(19) United States
(12) Patent Application Publication
(10) Pub. No.: US 2023/0417645 A1
(43) Pub. Date: Dec. 28, 2023

(54) DEVICE AND METHOD FOR RAPID DETERMINATION OF TOTAL BACTERIAL COUNT BASED ON MULTI-WAVELENGTH REFLECTANCE SPECTRUM

(71) Applicant: Jiamusi University, Jiamusi City (CN)

(72) Inventors: Xiaoyi CHEN, Jiamusi City (CN); Lina HU, Jiamusi City (CN); Shujing ZHOU, Jiamusi City (CN); Lixin DING, Jiamusi City (CN); Chaoxing WANG, Jiamusi City (CN); Yuguang LV, Jiamusi City (CN)

(21) Appl. No.: 18/155,327

(22) Filed: Jan. 17, 2023

(30) Foreign Application Priority Data
Jun. 28, 2022 (CN) 202210739102.X

(51) Int. Cl. G01N 15/06

(52) U.S. Cl. CPC G01N 15/06; G01N 2015/0693

(57) ABSTRACT

Disclosed is a device and method for rapid determination of total bacterial count. The device includes a light-emitting element, configured to emit a continuous light beam; a monochromator, arranged in an emitting direction of the light beam and configured to separate the light beam into monochromatic lights with different wavelengths; an integrating sphere, configured to receive the monochromatic light separated by the monochromator and converge the diffusely reflected monochromatic light; a thermostatic element, arranged in the integrating sphere and configured to keep a standard sample at a constant temperature, where diffuse reflection occurs after the monochromatic light irradiates on a constant-temperature standard sample; a photoelectric conversion element, connected to the integrating sphere and configured to convert an optical signal into an electric signal; and an oscilloscope, connected to the photoelectric conversion element and configured to read, calculate, and record the electric signal conducted by the photoelectric conversion element.

### CROSS-REFERENCE TO RELATED APPLICATION

This patent application claims the benefit and priority of Chinese Patent Application No. 202210739102.X, filed with the China National Intellectual Property Administration on Jun. 28, 2022, the disclosure of which is incorporated by reference herein in its entirety as part of the present application.

### FIELD OF THE DISCLOSURE

The present disclosure relates to the technical field of bacterial testing, and in particular relates to a device and method for rapid determination of total bacterial count based on multi-wavelength reflectance spectrum.

BACKGROUND

Total bacterial count refers to the total number of bacterial colonies produced in a gram (milliliter) of sample, which is obtained by culturing the sample on a common nutrient agar plate at 37° C. for 48 h under aerobic conditions and converting the count of the produced colonies. The total bacterial count is an important parameter index to determine the quality of a plurality of to-be-tested samples. When coming into contact with food and other samples with total bacterial count exceeding the standard, the human is easy to suffer from various diseases, endangering health and even life safety.

With the substantial improvement of living standards, people's requirements for food quality are getting higher and higher, and safe and high-quality food is increasingly favored by consumers. China's food industry, as a sunrise industry, has seen a rapid increase in its total output value in recent years, and there is an urgent need for rapid and efficient quality control means and testing equipment. The total bacterial count is an important biological index for food, the testing of its content is always throughout the whole production process of milk, meat and eggs, which is an important reference for evaluating the quality of food and is also a hygienic index mandatorily required by the state. Rapid and correct evaluation of the effectiveness of cleaning and disinfection of repeatedly used medical devices is an important factor for effective control of cross infection in hospital, and the occurrence of cross-contamination in hospital can be effectively controlled by sampling, culturing, monitoring, and rapidly detecting the bacteria. In addition, the daily chemical products are also very vulnerable to microbial contamination, especially the excessive total bacterial count may seriously damage the quality and economic benefits of the daily chemical products.

In the field of military affairs and national defense, due to the long-term service lurking below the water surface, the ventilation conditions of nuclear submarines are poor, leading to extremely serious bacterial pollution in submarine cabins. In addition, in space, living bacteria have been found outside the International Space Station. Long-distance space travel and long-term residence may be threatened by bacteria. Bacterial communities have a certain probability of mutating into deadly species in space radiation environment, and may even mutate when exposed to microgravity and space radiation environments. At present, the national defense security has been extended to “biological territory”. For example, the United States has issued three biological safety plans, such as Biosurveillance plan, and has conducted a series of research over the three plans, which plays an important role in rapid sample testing, biological anti-terrorism and food-borne disease prevention. Germany, Britain, Australia and other countries have also developed corresponding biological rapid testing plans, so biosafety plays an important role.

The national mandatory requirements for the total bacterial count include food, drinking water, daily chemicals and the like. Moreover, in the closed environment such as nuclear submarines and astronauts' living capsules, the problem of excessive total bacterial count is easy to be caused. Therefore, it is of a great significance for developing an instrument for rapid testing of total bacterial count with high testing speed, high accuracy and wide applicability to supervise the variation law of the total bacterial count of food, solid samples and drinking water, and to protect the health of soldiers and residents.

To achieve the determination of the total bacterial count of a sample, the researchers have developed a plurality of testing methods. Nowadays, the testing methods for total bacterial count are mainly divided into two types: one is the traditional standard plate count method, and the other is a series of new rapid testing methods, such as flow cytometry, electrical impedance analysis, ELISA (enzyme-linked immunosorbent assay), ATP (Adenosine triphosphate) bioluminescence, and turbidimetry. Although there are many methods for rapid testing of total bacterial count, so far, none of them can satisfy the requirements of accurate testing results, low operating cost and simple operation, and all of them have certain defects and applicable scope.
1. Standard plate count (SPC) is the most widely used method for the testing of total bacterial count. The aerobic bacterial count of the sample is obtained by culturing the sample on a common nutrient agar plate at 37° C. for 48 hours under aerobic conditions, and then counting the produced colonies. The SPC refers to that, under the specified conditions of Chinese standards (culture temperature, culture time and sample treatment process, etc.), the bacterial content in each milliliter of sample can be obtained by selecting 30 to 300 dilutions on each plate for counting and then multiplying them by dilution times. As the Chinese standard method, the plate count is used to determine the living bacteria, which is a more realistic reflection of the bacterial contamination in the sample, has the advantage of good repeatability, and is suitable for samples with high and low total bacterial counts. However, the main shortcomings of the SPC is as follows: (1) the operator is required to have skilled technology; (2) the result has a lag, which usually takes 2 days, but in production practice, the testing result should be real-time; (3) the obtained result is less than the actual value, and in the process of dilution, bacteria are not present singly in usual, but in clusters or chains formed by several or more bacteria, and if the sample is not uniformly diluted, the testing result may be low.
2. For the problems that the traditional testing method for the total bacterial count is long in time consuming and complex in operation, the development of a rapid bacterial testing method with simple operation, accurate result and suitability for large-batch samples has become a hot research topic. The accuracy of the flow cytometry is affected by bacteria species, dye coloring process and the degree of damage to bacteria itself during testing. ATP fluorescence cannot distinguish microbial ATP from non-microbial ATP, and some ions contained in the sample itself and in the ATP extractant may interfere with the ATP measurement and inhibit the luminescence, leading to low testing accuracy results; and the testing cost is increased due to expensive reagents.
3. Based on the defects of the above testing methods, the turbidimetry was further developed, referring to that under 600 nm monochromatic light, as the concentration of a bacterial suspension is inversely proportional to its transmittance in a certain range, the transmission ratio (T value) or absorbance A value is used to reflect the concentration of the sample bacterial solution. Such method is simple and easy to operate, rapid in testing speed, free of complex pretreatment process, and relatively high in accuracy. However, the turbidimetry still has the following shortcomings:
(1) The turbidimetry employs monochromatic light with one wavelength to reflect the absorbance value of all bacteria samples, without considering the influence of the individual difference of different bacteria species on the absorbance (the individual difference of different bacteria species leads to the difference of maximum absorption wavelength), which leads to the decrease of accuracy.
(2) The turbidimetry is only used for the determination of absorbance of a sample conforming to Beer-Lambert law's transmittance, without considering that many actual biological samples are in emulsion or suspension states (such as raw milk, etc.). Direct application of transmittance for the determination of absorbance of the sample may cause great error, resulting in the deviation of bacterial testing results.
(3) The turbidimetry cannot exclude the influence of the change of color of the sample itself on the absorbance, and for the darker sample, the error of the testing result is large.

### SUMMARY

To overcome the defects in the prior art, the present disclosure provides a device and method for rapid determination of total bacterial count based on multi-wavelength reflectance spectrum. The technical problem that the existing testing method has a large error in the testing result due to the differences in the size of individual bacteria, and the state and color of the sample is solved, thus achieving the purpose of rapidly and accurately determining the total bacterial count.

To solve the problems above, the technical solution employed by the present disclosure is as follows:

A device for rapid determination of total bacterial count based on multi-wavelength reflectance spectrum comprises:
a light-emitting element, configured to emit a continuous light beam;
a monochromator, arranged in an emitting direction of the light beam and configured to separate the light beam into monochromatic lights with different wavelengths;
an integrating sphere, configured to receive the monochromatic light separated by the monochromator and converge the diffusely reflected monochromatic light;
a thermostatic element, arranged in the integrating sphere and configured to keep a standard sample at a constant temperature, wherein diffuse reflection occurs after the monochromatic light irradiates on a constant-temperature standard sample;
a photoelectric conversion element, connected to the integrating sphere and configured to convert an optical signal into an electric signal; and
an oscilloscope, connected to the photoelectric conversion element and configured to read, calculate and record the electric signal conducted by the photoelectric conversion element.

As a preferred embodiment of the present disclosure, the photoelectric conversion element comprises:
an optical fiber, connected to the integrating sphere and configured to receive the monochromatic light converged by the integrating sphere; and
a photomultiplier, connected to the optical fiber and configured to convert an optical signal conducted by the optical fiber into an electric signal.

As a preferred embodiment of the present disclosure, the monochromator is an optical filter or an optical grating.

As a preferred embodiment of the present disclosure, the light-emitting element is a halogen lamp.

As a preferred embodiment of the present disclosure, the thermostatic element is a semiconductor temperature controller.

A method for rapid determination of total bacterial count based on multi-wavelength reflectance spectrum comprises the following steps:
sampling a to-be-tested sample, and preparing the to-be-tested sample into a standard sample;
carrying out heating treatment on the standard sample, and then measuring a first average reflected light intensity value of the standard sample at different wavelengths under the irradiation of the monochromatic light with different wavelengths;
after completing the first measurement, carrying out heating culture on the standard sample, and measuring a second average reflected light intensity value of the standard sample;
calculating a difference value between the first average reflected light intensity value and the second average reflected light intensity value; and
converting the difference value between the average reflected light intensity values into a value of the total bacterial count of the sample by means of a standard curve.

As a preferred embodiment of the present disclosure, the heating treatment condition is as follows: heating at 45° C. to 47° C. for 3 min to 5 min, and the heating culture condition is as follows: heating at 45° C. to 47° C. for 15 min to 17 min; and the total time for heating treatment and heating culture is 20 min.

As a preferred embodiment of the present disclosure, during preparation of the standard sample, the method comprises the following steps:
if the to-be-tested sample is water or emulsion or a water sample, directly and uniformly mixing the to-be-tested sample with sterile skim milk at a volume ratio of 1:1 to 2 to obtain a standard sample; and
if the to-be-tested sample is any one of solid, semi-solid, semi-fluid, gel-like, fluid and suspension samples, uniformly mixing the to-be-tested sample with normal saline to obtain a sample homogenate, wherein the content of the to-be-tested sample in the sample homogenate is 5% to 20% by weight; uniformly mixing the sample homogenate with the sterilized skim milk in a volume ratio of 1:1 to 2 to obtain a standard sample.

As a preferred embodiment of the present disclosure, the acquisition process of the standard curve is as follows:
sampling the to-be-tested sample for many times, randomly selecting any of collected samples, and preparing the collected sample into a standard sample;
carrying out heating treatment on the standard sample, and then measuring a first average reflected light intensity value of the standard sample at different wavelengths under the irradiation of the monochromatic light with different wavelengths;
after completing the first measurement, carrying out heating culture on the standard sample, and measuring a second average reflected light intensity value of the standard sample;
calculating a difference value between the first average reflected light intensity value and the second average reflected light intensity value;
continuing to select any of the collected samples, repeating the steps above until the difference value of the average reflected light intensity values of all collected samples is obtained; and
establishing a standard curve for the difference value of the reflected light intensity values and the true value of the total bacterial count by using the difference value of the average reflected light intensity values of all collected samples.

As a preferred embodiment of the present disclosure, the acquisition process of the true value of the total bacterial count is as follows: the total bacterial count of the standard sample subject to heating culture that is tested according to the testing of the Chinese standard GB4789.2-2016 is the true value of the total bacterial count.

Compared with the prior art, the present disclosure has the beneficial effects that:
(1) Monochromatic light with different wavelengths is adopted to determine the absorbance of the sample at different wavelengths, and an average value of the absorbance is calculated, thus solving the influence of individual difference of bacteria on the absorbance, and improving the testing accuracy.
(2) The present disclosure comprises the process of preparing the to-be-tested sample into the standard sample before bacteria determination, such that the problem of deviation of bacterial testing results caused by different states of the to-be-tested sample is solved, and the testing result is more accurate.
(3) By utilizing a relationship that the reflected light intensity is directly proportional to the total bacterial count, the problem of absorbance error caused by direct transmittance determination is effectively overcome, and the testing result is more accurate.
(4) Based on a difference method, the problem that the change of color of the sample itself has an impact on the absorbance is overcome, and the testing accuracy is effectively improved.
(5) No complex pretreatment process is required, the operation is simple and easy, and the testing speed is rapid.

The present disclosure is further described in detail below with reference to the accompanying drawings and specific embodiments.

### BRIEF DESCRIPTION OF THE DRAWINGS

FIG. 1 is a structure diagram of a device for rapid determination of total bacterial count based on multi-wavelength reflectance spectrum in accordance with an embodiment of the present disclosure;

FIG. 2 is a flow diagram of a method for rapid determination of total bacterial count based on multi-wavelength reflectance spectrum in accordance with an embodiment of the present disclosure;

FIG. 3 is a diagram illustrating a standard curve in accordance with an embodiment 1 of the present disclosure;

FIG. 4 is a diagram illustrating a standard curve in accordance with an embodiment 2 of the present disclosure;

In the drawings: 1—light-emitting element; 2—monochromator; 3—integrating sphere; 4—thermostatic element; 5—optical fiber; 6—photomultiplier; 7—oscilloscope.

### DETAILED DESCRIPTION

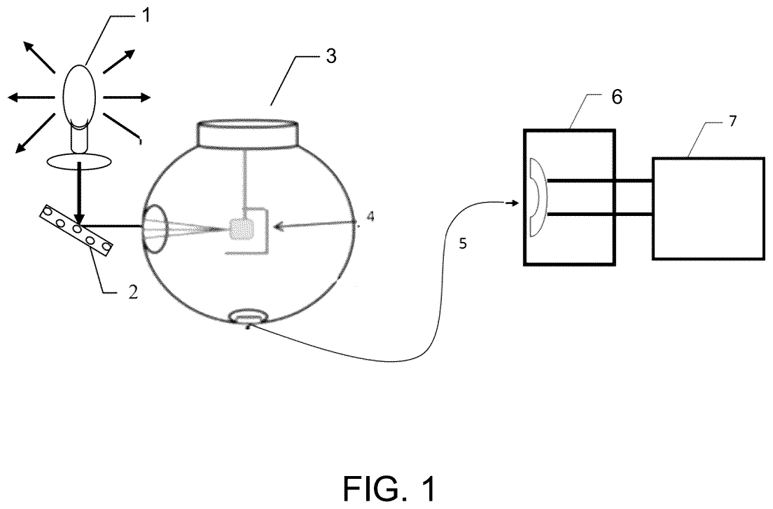

A device for rapid determination of total bacterial count based on multi-wavelength reflectance spectrum provided by the present disclosure, as shown in FIG. 1, comprises a light-emitting element 1, a monochromator 2, an integrating sphere 3, a thermostatic element 4, a photoelectric conversion element, and an oscilloscope 7. The light-emitting element 1 is configured to emit a continuous light beam. The monochromator 2 is arranged in an emitting direction of the light beam and configured to separate the light beam into monochromatic lights with different wavelengths. The integrating sphere 3 is configured to receive the monochromatic light separated by the monochromator and converge the diffusely reflected monochromatic light. The thermostatic element is arranged in the integrating sphere 3 and configured to keep a standard sample at a constant temperature, wherein diffuse reflection occurs after the monochromatic light irradiates on a constant-temperature standard sample. The photoelectric conversion element is connected to the integrating sphere 3 and configured to convert an optical signal into an electric signal. The oscilloscope 7 is connected to the photoelectric conversion element and configured to read, calculate and record the electric signal conducted by the photoelectric conversion element. Preferably, the oscilloscope 7 is a digital oscilloscope, which is internally provided with a microprocessor and externally provided with a digital display, and may be configured to perform an addition, a subtraction, a multiplication, a division, an average, a square root, a root mean square, and the like on the captured data of the waveform parameters, and display the answer number. The digital oscilloscope may employ and display the value of total bacterial count directly converted from the established standard curve.

The integrating sphere 3 comprises a hollow inner surface and is a spherical cavity with extremely high diffuse reflectivity, and its inner surface may be considered as a Lambert emitter, it is a photometric measuring instrument, commonly used in laser power and energy, material reflectivity measurement, etc. When a beam of laser enters the integrating sphere, a uniform and isotropic diffuse-reflection optical field may be formed in the integrating sphere. The use of integrating sphere 3 may reduce and remove the measurement error caused by differences in light shape, divergence angle and responsiveness at different locations on the measurement device.

The thermostatic element 4 is designed for the condition that most of actual biological samples present different sample states such as emulsions or suspensions. After the monochromatic light passes through the standard sample inside the thermostatic element 4, diffuse reflection occurs in the integrating sphere 3, and the absorption of the diffuse reflectance spectroscopy of the standard sample is determined. Therefore, the problem of absorbance error caused by direct transmittance determination is effectively overcome by using a relationship that the reflected light intensity is directly proportional to the total bacterial count.

The testing process of the present disclosure is as follows:
(1) On an ultra-clean workbench, a power line is connected to the device and a power supply of the device is turned, and the device starts self-inspection at the moment; the completion of the testing is promoted after the self-inspection is completed, where the self-inspection lasts for about 10 min; the preheating needs to be continued for 30 min after the self-inspection, and then the device can be used to test the sample.
(2) A BaSO4 standard white material is used as a reflectance reference, and its reflected light intensity value is determined and automatically set to be 100%.
(3) 1.0 mL of liquid sample is added into a test cup, and then 1.0 mL of skim milk is added into the test cup, the liquid sample and the skim milk are fully and uniformly mixed to obtain a standard sample. The standard sample is placed into the thermostatic element 4, the temperature of the thermostatic element 4 is set to be 47° C., and then the standard sample is preheated at 47° C. for 5 min.
(4) After the standard sample is preheated for 5 min, a continuous light beam is emitted by the light-emitting light beam 1, the monochromator 2 is configured to separate the light beam into monochromatic light with different wavelengths, preferably separating the light beam into monochromatic light with four wavelengths of 440 nm, 520 nm, 600 nm, and 640 nm; the monochromatic light with different wavelengths irradiates on the constant-temperature standard sample in the thermostatic element 4 to generate diffuse reflection; the diffusely reflected monochromatic light is converged by the integrating sphere 3; and after an optical signal is converted into an electric signal by the photoelectric conversion element, the oscilloscope 7 is configured to read an initial reflected light intensity value of the tested sample, and automatically set the initial reflected light intensity value to be the number “0”.
(5) The test cup is continued to be placed into the thermostatic element 4 at 47° C., after being cultured for 15 min at a constant temperature, the reflected light intensity value of the liquid sample after culture is tested by using the determination device. After the liquid sample is cultured for 20 min, its reflected light intensity value increases due to the production of bacteria, the instrument records the reflected light intensity value of the tested liquid sample at the moment. After mass sampling and testing, the reflected light intensity value of the sample that has been cultured for 20 min is fitted as a curve equation with the true value of the total bacterial count to establish a standard curve, and the standard curve is input to the oscilloscope 7.

In the subsequent testing, the reflected light intensity values of the liquid sample at 5 min and 20 min are determined according to the above steps, and the oscilloscope 7 is configured to convert the reflected light intensity value into the value of total bacterial count of the sample by using the standard curve and display the value of total bacterial count.

Further, the determination device is further provided with a “view” button, and the testing result of the sample may be displayed by pressing the “view” button.

Further, the determination device is further provided with a “print” button, and this measurement result may be printed by pressing the “print” button.

Further, the determination device may be used together with software sscom 3.2, the data is recorded and converted into TXT text files by the software, so the determined data can be conveniently analyzed, compared and tracked later, and then is stored in a flash memory medium.

Further, the photoelectric conversion element comprises an optical fiber 5 and a photomultiplier 6. The optical fiber 5 is connected to the integrating sphere 3 and configured to receive the monochromatic light converged by the integrating sphere 3, and the photomultiplier 6 is connected to the optical fiber 5 and configured to convert an optical signal conducted by the optical fiber 5 into an electric signal.

The photomultiplier 6 is a photoelectric induction element based on external photoelectric effect, secondary electron emission and electron optics theory, which is generally used in the ultraviolet, visible and near-infrared regions of the spectrum in practice. In addition to a photocathode and an anode, the internal structure of the photomultiplier 6 has a plurality of tile-shaped dynodes placed between two poles thereof. In use, voltage accelerating electrons may be generated between two adjacent dynodes in the tube. The photocathode of the photomultiplier 6 may release photoelectrons after being irradiated by a light source, and then the photoelectrons may irradiate on first dynodes under the action of an electric field to form the secondary emission and the tertiary emission of electrons, finally causing continuous multiplication of the number of electrons in the tube. Finally, the electrons collected by the anode of the photomultiplier 6 may be increased by 104 to 108 times, and weak optical signals in the system can be detected.

Further, the monochromator 2 is an optical filter or an optical grating. The optical filter is a Fabry-Perot optical filter, which uses liquid crystal as the cavity material, and has the advantages of narrow bandwidth, low energy consumption, wide tuning range, low driving voltage, simple structure, etc.

A large number of parallel notches with equal width and equal spacing are engraved on a transparent glass sheet to form the optical grating, where the notches are opaque parts. Generally, there are dozens or even thousands of slits per millimeter in the optical grating. When light waves are transmitted or reflected on the optical grating, diffraction may occur to form a certain diffraction pattern. Due to the fact that the light with different wavelengths has different diffraction angles, the light with different wavelengths in the incident light can be separated by the optical grating.

Further, the light-emitting element 1 is a halogen lamp. The principle of the halogen lamp is that the halogen gas such as iodine or bromine is injected into the bulb, the sublimated tungsten wire reacts with halogen at a high temperature, and the cooled tungsten will re-solidify on the tungsten wire to form a balanced cycle to prevent the tungsten wire from premature fracture, and therefore the halogen lamp has a longer life than an incandescent lamp.

Further, the thermostatic element 4 is a semiconductor temperature controller. The semiconductor temperature controller has the following advantages: (1) it has a simple structure, no refrigerant, no wear, long life, high working reliability, and low requirements for working environment; (2) heating temperature and speed may be controlled by the working current, and the control is flexible and the start is fast; (3) the volume is small, the weight is light, and the maintenance is convenient; (4) the control precision is high; and (5) the temperature control range is wide. Therefore, the accuracy of the determination result may be further ensured by using the semiconductor temperature controller.

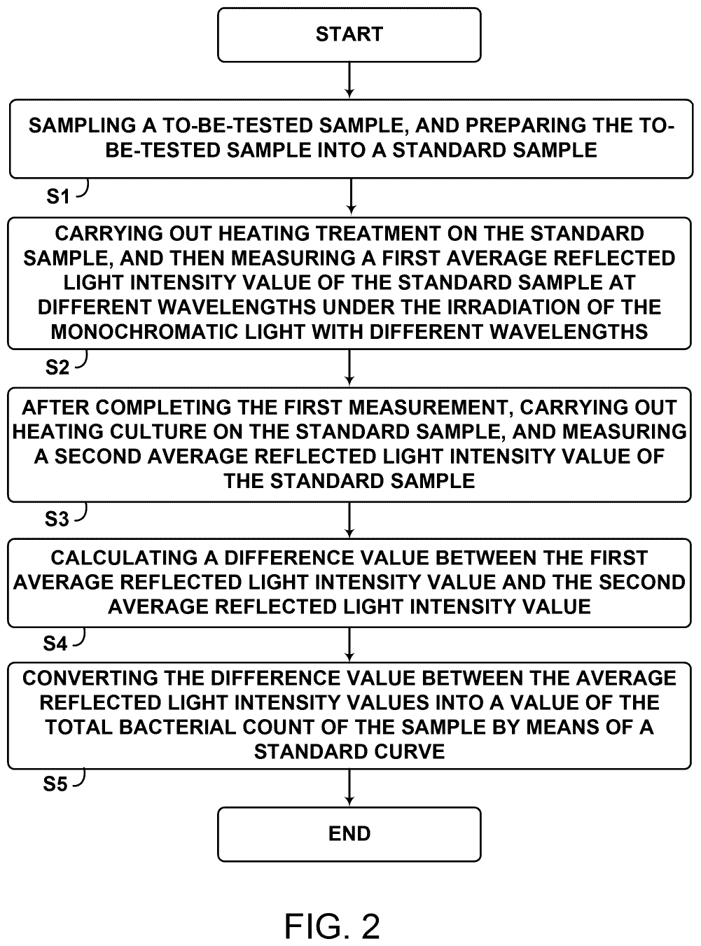

A method for rapid determination of total bacterial count based on multi-wavelength reflectance spectrum provided by the present disclosure, as shown in FIG. 2, comprises the following steps:
S1: sampling a to-be-tested sample, and preparing the to-be-tested sample into a standard sample;
S2: carrying out heating treatment on the standard sample, and then measuring a first average reflected light intensity value of the standard sample at different wavelengths under the irradiation of the monochromatic light with different wavelengths;
S3: after completing the first measurement, carrying out heating culture on the standard sample, and measuring a second average reflected light intensity value of the standard sample;
S4: calculating a difference value between the first average reflected light intensity value and the second average reflected light intensity value; and
S5: converting the difference value between the average reflected light intensity values into a value of the total bacterial count of the sample by means of a standard curve.

In the step S2, the heating treatment condition is as follows: heating at 45° C. to 47° C. for 3 min to 5 min, and the heating culture condition is as follows: heating at 45° C. to 47° C. for 15 min to 17 min; and the total time for heating treatment and heating culture is 20 min.

Further, after being heated at 47° C. for 5 min, the standard sample is used as a blank, its reflected light intensity value is determined, and after being continuously cultured at 47° C. for 15 min, its reflected light intensity value is determined again. As the variation of the reflected light intensity of the mixed liquid is caused by bacterial reproduction, the interference of the sample color on the determination result may be eliminated by using the difference between two reflected light intensity values. Meanwhile, as the bacteria are reproduced in a binary fission manner, the total bacterial count of the standard sample after 20 min is increased twice as much as the original, and the value of total bacterial count of the original sample may be obtained from the value of total bacterial count of the standard sample.

In the above step S2, different wavelengths of the monochromatic light are 440 nm, 520 nm, 600 nm and 640 nm, respectively. The monochromatic light with different wavelengths is configured to determine the absorbance of the sample at different wavelengths, and then an average value of the absorbance is calculated; the maximum absorption wavelength of the giant bacteria is at 440 nm, the maximum absorption wavelength of the large bacteria is at 520 nm, the maximum absorbance wavelength of the small bacteria is at 640 nm, and the maximum absorbance wavelength of the medium-sized bacteria is at 580 to 600 nm. The monochromatic light with the four wavelengths can embrace the bacteria with different individual sizes, thus overcoming the technical problem of different maximum absorption wavelengths caused by the difference of individual sizes of different species of bacteria.

Further, during preparation of the standard sample, the method comprises:
If the to-be-tested sample is water or emulsion or a water sample, directly and uniformly mixing the to-be-tested sample with sterile skim milk at a volume ratio of 1:1 to 2 to obtain a standard sample;
if the to-be-tested sample is any one of solid, semi-solid, semi-fluid, gel-like, fluid and suspension samples, uniformly mixing the to-be-tested sample with normal saline to obtain a sample homogenate, wherein the content of the to-be-tested sample in the sample homogenate is 5% to 20% by weight; uniformly mixing the sample homogenate with the sterilized skim milk in a volume ratio of 1:1 to 2 to obtain a standard sample.

The steps are specifically as follows:
If the to-be-tested sample is an emulsion or water, the to-be-tested sample is uniformly mixed with sterilized skim milk at a volume ratio of 1:1 to 2 to obtain a standard sample.
If the to-be-tested sample is solid or semi-fluid, the to-be-tested sample is uniformly mixed with normal saline to obtain a sample homogenate, which contains 10% by weight of to-be-tested sample; and the sample homogenate is uniformly mixed with the sterilized skim milk in a volume ratio of 1:1 to 2 to obtain the standard sample.
If the to-be-tested sample is semi-solid, the to-be-tested sample is uniformly mixed with normal saline to obtain a sample homogenate, which contains 15% by weight of to-be-tested sample; and the sample homogenate is uniformly mixed with the sterilized skim milk in a volume ratio of 1:1 to 2 to obtain the standard sample.
If the to-be-tested sample is gel-like, the to-be-tested sample is uniformly mixed with normal saline to obtain a sample homogenate, which contains 20% by weight of to-be-tested sample; and the sample homogenate is uniformly mixed with the sterilized skim milk in a volume ratio of 1:1 to 2 to obtain the standard sample.
If the to-be-tested sample is a fluid, the to-be-tested sample is uniformly mixed with normal saline to obtain a sample homogenate, which contains 5% by weight of to-be-tested sample; and the sample homogenate is uniformly mixed with the sterilized skim milk in a volume ratio of 1:1 to 2 to obtain the standard sample.
If the to-be-tested sample is a suspension, the to-be-tested sample is uniformly mixed with normal saline to obtain a sample homogenate, which contains 10% by weight of to-be-tested sample; the sample homogenate is centrifuged, and then a supernatant thereof is uniformly mixed with the sterilized skim milk in a volume ratio of 1:1 to 2 to obtain the standard sample.

Further, the acquisition process of the standard curve is as follows:
sampling the to-be-tested sample for many times, randomly selecting any of collected samples, and preparing the collected sample into a standard sample;
carrying out heating treatment on the standard sample, and then measuring a first average reflected light intensity value of the standard sample at different wavelengths under the irradiation of the monochromatic light with different wavelengths;
after completing the first measurement, carrying out heating culture on the standard sample, and measuring a second average reflected light intensity value of the standard sample;
calculating a difference value between the first average reflected light intensity value and the second average reflected light intensity value;
continuing to select any of the collected samples, repeating the steps above until the difference value of the average reflected light intensity values of all collected samples is obtained; and
establishing a standard curve for the difference value of the reflected light intensity values and the true value of the total bacterial count by using the difference value of the average reflected light intensity values of all collected samples.

Further, the acquisition process of the true value of the total bacterial count is as follows: according to the testing of the Chinese standard GB4789.2-2016 Food microbiological examination: Aerobic plate count, the total bacterial count of the standard sample after heating culture is the true value of the total bacterial count. The standard specifies the determination method for aerobic plate count of food.

The present disclosure is further described below with specific embodiments

### EMBODIMENTS 1 TO 15

Testing of Emulsion Samples (Raw Milk, Milk Beverage, etc.)

A true value of total bacterial count of a dairy product is tested by using a standard plate count (GB4789.2-2016). 1.0 mL of dairy product is added into 1.0 mL of sterilized skim milk, an absorbance value determined by an instrument is used as a reference value, an initial absorbance value of the to-be-tested emulsion sample is set to be 0; by taking a BaSO4 standard white material as a reflectance reference, an initial reflected light intensity value of the instrument is set to be 100%, after being heated at 47° C. for 5 min, the mixed liquid is used as a blank, and its reflected light intensity value is determined; after being continuously cultured at 47° C. for 15 min, its reflected light intensity value is determined again; and after being cultured for 20 min, its reflected light intensity value increases due to the production of the bacteria. The reflected light intensity value of the tested dairy product is recorded by the instrument at the moment; and after mass sampling and testing, the reflected light intensity value of the dairy product that has been cultured for 20 min is fitted as a curve equation with the true value of the total bacterial count to establish a standard curve.

Reflected light intensity values of 15 groups of emulsion samples (including raw milk, milk beverage, etc.) are determined according to above steps, and then the reflected light intensity values thereof are converted into the values of total bacterial count of the samples by using the standard curve.

### EMBODIMENTS 16 TO 30

Testing of Water Samples:

10 mL of water sample is subjected to sterile filtration by using a filtering membrane having a pore size of 10 μm to remove solid particles in the water so as to exclude interference thereof on the test. 1.0 mL of water sample after sterile filtration is added into 1.0 mL of sterilized skim milk, an absorbance value determined by an instrument is used as a reference value, an initial absorbance value of the to-be-tested water sample is set to be 0; by taking a BaSO4 standard white material as a reflectance reference, an initial reflected light intensity value of the instrument is set to be 100%, after being heated at 47° C. for 5 min, the mixed liquid is used as a blank, and its reflected light intensity value is determined; after being continuously cultured at 47° C. for 15 min, its reflected light intensity value is determined again; and after being cultured for 20 min, its reflected light intensity value increases due to the production of the bacteria. The reflected light intensity value of the tested water sample is recorded by the instrument at the moment; and after mass sampling and testing, the reflected light intensity value of the water sample that has been cultured for 20 min is fitted as a curve equation with the true value of the total bacterial count to establish a standard curve.

Reflected light intensity values of 15 groups of water samples (including barreled water, water of rivers and lakes, etc.) are determined according to above steps, and then the reflected light intensity values thereof are converted into the values of total bacterial count of the samples by using the standard curve.

### EMBODIMENTS 31 TO 45

Testing of Solid Samples:

25.00 g of solid sample (bread, candies, preserved fruit, sausage, etc.) is placed into a sterile homogenizing cup filled with 225.00 mL of normal saline, and is homogenized at 8,000 r/min to 10,000 r/min for 1 min to 2 min; or the 25.00 g of solid sample is placed into a sterile homogenizing bag filled with 225 mL of diluent, and then is flapped by a flapping homogenizer for 1 min to 2 min so as to obtain a sample homogenate with a solid sample weight ratio of 10% for later use.

1.0 mL of sample homogenate is added into 1.0 mL of sterilized skim milk, an absorbance value determined by an instrument is used as a reference value, an initial absorbance value of the to-be-tested solid sample is set to be 0; by taking a BaSO4 standard white material as a reflectance reference, an initial reflected light intensity value of the instrument is set to be 100%, after being heated at 47° C. for 5 min, the mixed liquid is used as a blank, and its reflected light intensity value is determined; after being continuously cultured at 47° C. for 15 min, its reflected light intensity value is determined again; and after being cultured for 20 min, its reflected light intensity value increases due to the production of the bacteria. The reflected light intensity value of the tested solid sample is recorded by the instrument at the moment; and after mass sampling and testing, the reflected light intensity value of the solid sample that has been cultured for 20 min is fitted as a curve equation with the true value of the total bacterial count to establish a standard curve.

Reflected light intensity values of 15 groups of solid samples (including candies, sausages, etc.) are respectively determined according to above steps, and then the reflected light intensity values are converted into the values of total bacterial count of the samples by using the standard curve.

### EMBODIMENTS 46 TO 60

Testing of Semi-Solid Samples:

15.00 g of semi-solid sample (vegetable puree, fruit puree, etc.) is placed into a conical flask filled with 85.00 mL of normal saline, and then is uniformly mixed with the normal saline by a vortex mixer to obtain a sample homogenate with a semi-solid sample weight ratio of 15% for later use.

1.0 mL of sample solution after pretreatment of the semi-solid sample is added into 1.0 mL of sterilized skim milk, an absorbance value determined by an instrument is used as a reference value, an initial absorbance value of the to-be-tested semi-solid sample is set to be 0; by taking a BaSO4 standard white material as a reflectance reference, an initial reflected light intensity value of the instrument is set to be 100%, after being heated at 47° C. for 5 min, the mixed liquid is used as a blank, and its reflected light intensity value is determined; after being continuously cultured at 47° C. for 15 min, its reflected light intensity value is determined again; and after being cultured for 20 min, its reflected light intensity value increases due to the production of the bacteria. The reflected light intensity value of the tested semi-solid sample is recorded by the instrument at the moment; and after mass sampling and testing, the reflected light intensity value of the semi-solid sample that has been cultured for 20 min is fitted as a curve equation with the true value of the total bacterial count to establish a standard curve.

Reflected light intensity values of 15 groups of semi-solid samples (including rice, flour, etc.) are respectively determined according to above steps, and then the reflected light intensity values are converted into the values of total bacterial count of the samples by using the standard curve.

### EMBODIMENTS 61 TO 75

Testing of Semi-Fluid Samples:

10.00 g of semi-fluid sample (daily chemical product, mixed congee, etc.) is placed into a conical flask filled with 90.00 mL of normal saline, and then is uniformly mixed with the normal saline by a vortex mixer to obtain a sample homogenate with a semi-fluid sample weight ratio of 10% for later use.

1.0 mL of sample homogenate is added into 1.0 mL of sterilized skim milk, an absorbance value determined by an instrument is used as a reference value, an initial absorbance value of the to-be-tested semi-fluid sample is set to be 0; by taking a BaSO4 standard white material as a reflectance reference, an initial reflected light intensity value of the instrument is set to be 100%, after being heated at 47° C. for 5 min, the mixed liquid is used as a blank, and its reflected light intensity value is determined; after being continuously cultured at 47° C. for 15 min, its reflected light intensity value is determined again; and after being cultured for 20 min, its reflected light intensity value increases due to the production of the bacteria. The reflected light intensity value of the tested semi-fluid sample is recorded by the instrument at the moment; and after mass sampling and testing, the reflected light intensity value of the semi-fluid sample that has been cultured for 20 min is fitted as a curve equation with the true value of the total bacterial count to establish a standard curve.

Reflected light intensity values of 15 groups of semi-fluid samples (including rice, flour, etc.) are respectively determined according to above steps, and then the reflected light intensity values are converted into the values of total bacterial count of the samples by using the standard curve.

### EMBODIMENTS 76 TO 90

Testing of Gel-Like Samples:

20.00 g of gel-like samples (Doufu, etc.) is placed into a sterile homogenizing cup filled with 80.00 mL of normal saline, and then is homogenized at 8,000 r/min to 10,000 r/min for 1 min to 2 min to obtain a sample homogenate with a gel-like sample weight ratio of 20% for later use.

1.0 mL of sample solution after the pretreatment of the gel-like sample is added into 1.0 mL of sterilized skim milk, an absorbance value determined by an instrument is used as a reference value, an initial absorbance value of the to-be-tested gel-like sample is set to be 0; by taking a BaSO4 standard white material as a reflectance reference, an initial reflected light intensity value of the instrument is set to be 100%, after being heated at 47° C. for 5 min, the mixed liquid is used as a blank, and its reflected light intensity value is determined; after being continuously cultured at 47° C. for 15 min, its reflected light intensity value is determined again; and after being cultured for 20 min, its reflected light intensity value increases due to the production of the bacteria. The reflected light intensity value of the tested gel-like sample is recorded by the instrument at the moment; and after mass sampling and testing, the reflected light intensity value of the gel-like sample that has been cultured for 20 min is fitted as a curve equation with the true value of the total bacterial count to establish a standard curve.

Reflected light intensity values of 15 groups of gel-like samples (jellies, etc.) are respectively determined according to above steps, and then the reflected light intensity values are converted into the value of the total bacterial count of the sample by using the standard curve.

### EMBODIMENTS 91 TO 105

Testing of Fluid Samples:

10.00 g of fluid sample (juice, soybean milk, etc.) is placed into a conical flask filled with 190.00 mL of normal saline, and then is uniformly mixed with the normal saline by a vortex mixer to obtain a sample homogenate with a fluid sample weight ratio of 5% for later use.

1.0 mL of sample solution after the pretreatment of the fluid sample is added into 1.0 mL of sterilized skim milk, an absorbance value determined by the instrument is used as a reference value, an initial absorbance value of the to-be-tested fluid sample is set to be 0; by taking a BaSO4 standard white material as a reflectance reference, an initial reflected light intensity value of the instrument is set to be 100%, after being heated at 47° C. for 5 min, the mixed liquid is used as a blank, and its reflected light intensity value is determined; after being continuously cultured at 47° C. for 15 min, its reflected light intensity value is determined again; and after being cultured for 20 min, its reflected light intensity value increases due to the production of the bacteria. The reflected light intensity value of the tested fluid sample is recorded by the instrument at the moment; and after mass sampling and testing, the reflected light intensity value of the fluid sample that has been cultured for 20 min is fitted as a curve equation with the true value of the total bacterial count to establish a standard curve.

Reflected light intensity values of 15 groups of fluid samples (broth, etc.) are respectively determined according to above steps, and then the reflected light intensity values are converted into the value of the total bacterial count of the sample by using the standard curve.

### EMBODIMENTS 105 TO 120

Suspension Samples

20.00 g of suspension sample (blood, etc.) is placed into a conical flask filled with 800.00 mL of normal saline, and then is uniformly mixed with the normal saline by a vortex mixer to obtain a sample homogenate with a suspension sample weight ratio of 10% for later use; then the sample homogenate is centrifuged by a centrifuge at 7,000 rpm to 10,000 rpm for 15 min to obtain supernatant for later use.

1.0 mL of sample solution after the pretreatment of the suspension sample is added into 1.0 mL of sterilized skim milk, an absorbance value determined by the instrument is used as a reference value, an initial absorbance value of the to-be-tested suspension sample is set to be 0; by taking a BaSO4 standard white material as a reflectance reference, an initial reflected light intensity value of the instrument is set to be 100%, after being heated at 47° C. for 5 min, the mixed liquid is used as a blank, and its reflected light intensity value is determined; after being continuously cultured at 47° C. for 15 min, its reflected light intensity value is determined again; and after being cultured for 20 min, its reflected light intensity value increases due to the production of the bacteria. The reflected light intensity value of the tested suspension sample is recorded by the instrument at the moment; and after mass sampling and testing, the reflected light intensity value of the suspension sample that has been cultured for 20 min is fitted as a curve equation with the true value of the total bacterial count to establish a standard curve.

Reflected light intensity values of 15 groups of suspension samples (Barium sulfate suspension, etc.) are respectively determined according to above steps, and then the reflected light intensity values are converted into the value of the total bacterial count of the sample by using the standard curve.

The total bacterial count of 15 groups (Examples 1-15) of emulsion samples is determined by the device and method of the present disclosure (hereinafter referred to as instrumental method), and the accuracy is analyzed. The specific determination results and analysis results are shown in Table 1 and Table 2:

TABLE 1
Measurement results of total bacterial count
of emulsion samples by instrumental method and Chinese
standard method (unit: 10⁴ cfu/mL)

| Serial number | Standard plate count | Instrumental method |
|---|---|---|
| Embodiment 1 | 7.07 ± 0.61 | 7.28 ± 0.73 |
| Embodiment 2 | 3.16 ± 0.82 | 3.07 ± 0.93 |
| Embodiment 3 | 116.23 ± 8.56 | 118.50 ± 6.20 |
| Embodiment 4 | 63.02 ± 4.32 | 65.25 ± 5.22 |
| Embodiment 5 | 11.56 ± 1.35 | 11.30 ± 1.72 |
| Embodiment 6 | 81.05 ± 10.92 | 82.02 ± 11.83 |
| Embodiment 7 | 0.54 ± 0.04 | 0.52 ± 0.05 |
| Embodiment 8 | 2.18 ± 0.08 | 2.12 ± 0.06 |
| Embodiment 9 | 72.50 ± 3.52 | 73.89 ± 4.32 |
| Embodiment 10 | 225.04 ± 27.62 | 219.67 ± 28.54 |
| Embodiment 11 | 19.53 ± 1.12 | 19.38 ± 1.25 |
| Embodiment 12 | 10.52 ± 0.67 | 11.21 ± 0.74 |
| Embodiment 13 | 215.17 ± 23.54 | 212.61 ± 24.58 |
| Embodiment 14 | 0.48 ± 0.04 | 0.42 ± 0.04 |
| Embodiment 15 | 9.85 ± 0.65 | 9.78 ± 0.86 |

TABLE 2
Comparative analysis of emulsion samples
by T-test of instrumental method

| 95% Confidence interval | | | | |
|---|---|---|---|---|
| of difference value | | | Degree of | Significance |
| Lower limit | Upper limit | T value | freedom | (P value) |
| −15335409.01 | 5590391.78 | −0.999 | 14 | 0.335 |

It can be known from Table 2 that, within the 95% confidence interval, a P value (Two-tailed value) obtained by paired T-test is 0.335, P>0.05, and P value greater than 0.05 (i.e., the difference between the samples is not significant) indicates that there is no significant difference between the results of the total bacterial count of the emulsion sample tested by the instrumental method and by the standard method (standard plate count), and the accuracy of the total bacterial count of the emulsion sample tested by the instrumental method is high.

The total bacterial count of 15 groups (Examples 16-30) of water samples is determined by the instrumental method (embodiments 16 to 30), and the accuracy is analyzed. The specific determination results and analysis results are shown in Table 3 and Table 4:

TABLE 3
Measurement results of total bacterial count
of water samples by instrumental method and Chinese
standard method (unit: 10⁴ cfu/mL)

| Serial number | Standard plate count | Instrumental method |
|---|---|---|
| Embodiment 16 | 1472 ± 98 | 1658 ± 102 |
| Embodiment 17 | 11200 ± 702 | 10512 ± 675 |
| Embodiment 18 | 3085 ± 253 | 3156 ± 201 |
| Embodiment 19 | 7080 ± 405 | 7258 ± 396 |
| Embodiment 20 | 14210 ± 3150 | 14027 ± 3240 |
| Embodiment 21 | 12410 ± 2245 | 12504 ± 1865 |
| Embodiment 22 | 125 ± 8 | 108 ± 7 |
| Embodiment 23 | 365 ± 15 | 347 ± 16 |
| Embodiment 24 | 1400 ± 92 | 1385 ± 77 |
| Embodiment 25 | 800 ± 38 | 823 ± 54 |
| Embodiment 26 | 13400 ± 3170 | 13252 ± 2368 |
| Embodiment 27 | 12120 ± 928 | 12567 ± 796 |
| Embodiment 28 | 420 ± 35 | 385 ± 21 |
| Embodiment 29 | 100 ± 9 | 93 ± 6 |
| Embodiment 30 | 290 ± 25 | 306 ± 23 |

TABLE 4
Comparative analysis of water samples
by T-test of instrumental method

| 95% Confidence interval | | | | |
|---|---|---|---|---|
| of difference value | | | Degree of | Significance |
| Lower limit | Upper limit | T value | freedom | (P value) |
| −382.32 | 271.12 | −0.365 | 14 | 0.721 |

It can be known from Table 4 that, within the 95% confidence interval, the P value (two-tailed value) obtained by paired T-test is 0.721, P>0.05, and P value greater than 0.05 (i.e., the difference between samples is not significant) indicates that there is no significant difference between the results of the total bacterial count of the water sample tested by the instrumental method and by the standard method (standard plate count), and the accuracy of the total bacterial count of the water sample tested by the instrumental method is high.

Solid, semi-solid, semi-fluid, gel-like, fluid and suspension samples (embodiments 30 to 120) are compared and analyzed by T-test, and the P values are all greater than 0.05, indicating that there is no significant difference between the results of the total bacterial count of the above samples tested by the instrumental method and by the standard method, and the accuracy of the value of total bacterial count of the above samples tested by the instrumental method is high.

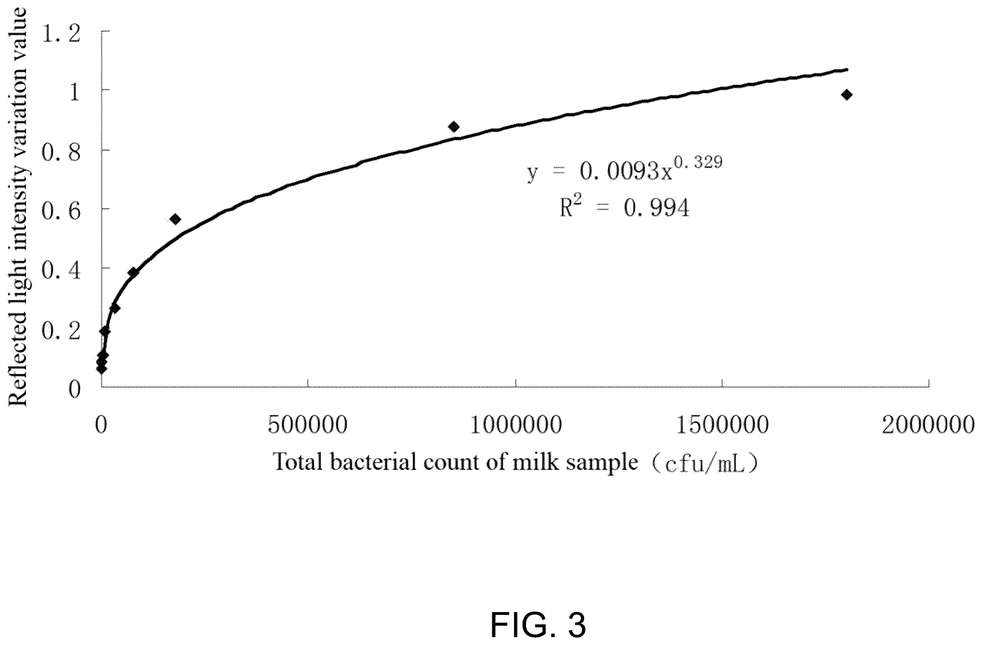

The standard curve established for the emulsion sample is as shown in FIG. 3. It can be seen from FIG. 3 that R2=0.994, R2 is a correlation coefficient of the standard curve for evaluating the coincidence degree between the test data and the fitting function. The closer the R2 value is to 1, the higher the coincidence degree is, so the standard curve established by the emulsion sample is highly consistent with the determined data.

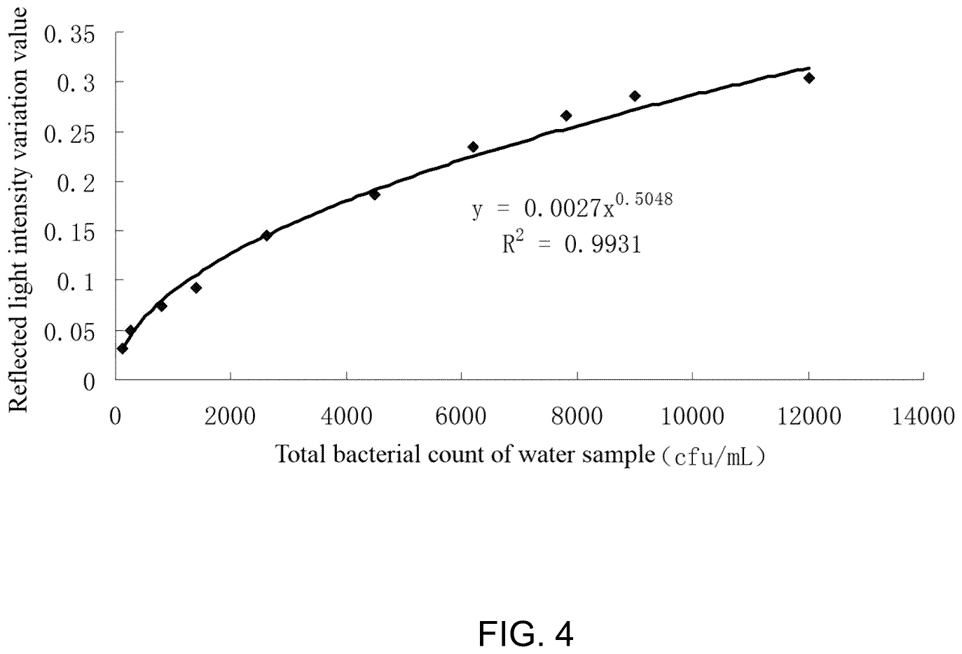

The standard curve established for the water sample is as shown in FIG. 4. It can be seen from FIG. 4 that R2=0.9931, so the standard curve established for the water sample is highly consistent with the determined data.

It can be seen from the standard curves established for the solid, semi-solid, semi-fluid, gel-like, fluid and suspension samples that R2 is all greater than 99%, so the standard curves established for the solid, semi-solid, semi-fluid, gel-like, fluid and suspension samples are highly consistent with the determined data.

It can be known from above that the P values of comparative analysis results of T-test in all embodiments are all greater than 0.05, and correlation coefficient R2 values of the standard curves established for various samples are all greater than 99%, fully indicating that the total bacterial count of emulsion, water, solid, semi-solid, semi-fluid, gel-like, fluid and suspension samples can be accurately determined by using the device and method of the present disclosure, and the technical problem of large determination error in the prior art is overcome.

The above-mentioned embodiments are only the preferred embodiments of the present disclosure, and are not intended to limit the scope of the present disclosure. Any insubstantial changes and substitutions made by those skilled in the art on the basis of the present disclosure are within the scope of the present disclosure.

1-10. (canceled)

11. A device for rapid determination of total bacterial count based on multi-wavelength reflectance spectrum, comprising:
a light-emitting element, configured to emit a continuous light beam;
a monochromator, arranged in an emitting direction of the light beam and configured to separate the light beam into monochromatic lights with different wavelengths;
an integrating sphere, configured to receive the monochromatic light separated by the monochromator and converge the diffusely reflected monochromatic light;
a thermostatic element, arranged in the integrating sphere and configured to keep a standard sample at a constant temperature, wherein diffuse reflection occurs after the monochromatic light irradiates on a constant-temperature standard sample;
a photoelectric conversion element, connected to the integrating sphere and configured to convert an optical signal into an electric signal; and
an oscilloscope, connected to the photoelectric conversion element and configured to read, calculate and record the electric signal conducted by the photoelectric conversion element.

12. The device for rapid determination of total bacterial count based on multi-wavelength reflectance spectrum according to claim 11, wherein the photoelectric conversion element comprises:
an optical fiber, connected to the integrating sphere and configured to receive the monochromatic light converged by the integrating sphere; and
a photomultiplier, connected to the optical fiber and configured to convert an optical signal conducted by the optical fiber into an electric signal.

13. The device for rapid determination of total bacterial count based on multi-wavelength reflectance spectrum according to claim 11, wherein the monochromator is an optical filter or an optical grating.

14. The device for rapid determination of total bacterial count based on multi-wavelength reflectance spectrum according to claim 11, wherein the light-emitting element is a halogen lamp.

15. The device for rapid determination of total bacterial count based on multi-wavelength reflectance spectrum according to claim 11, wherein the thermostatic element is a semiconductor temperature controller.

16. A method for rapid determination of total bacterial count based on multi-wavelength reflectance spectrum, comprising the following steps:
sampling a to-be-tested sample, and preparing the to-be-tested sample into a standard sample;
carrying out heating treatment on the standard sample, and then measuring a first average reflected light intensity value of the standard sample at different wavelengths under the irradiation of the monochromatic light with different wavelengths;
after completing the first measurement, carrying out heating culture on the standard sample, and measuring a second average reflected light intensity value of the standard sample;
calculating a difference value between the first average reflected light intensity value and the second average reflected light intensity value; and
converting the difference value between the average reflected light intensity values into a value of the total bacterial count of the sample by means of a standard curve.

17. The method for rapid determination of total bacterial count based on multi-wavelength reflectance spectrum according to claim 16, wherein the heating treatment condition is as follows: heating at 45° C. to 47° C. for 3 min to 5 min, and the heating culture condition is as follows: heating at 45° C. to 47° C. for 15 min to 17 min; and the total time for heating treatment and heating culture is 20 min.

18. The method for rapid determination of total bacterial count based on multi-wavelength reflectance spectrum according to claim 16, wherein, during preparation of the standard sample, the method comprises:
if the to-be-tested sample is water or emulsion or a water sample, directly and uniformly mixing the to-be-tested sample with sterile skim milk at a volume ratio of 1:1 to 2 to obtain a standard sample; and
if the to-be-tested sample is any one of solid, semi-solid, semi-fluid, gel-like, fluid and suspension samples, uniformly mixing the to-be-tested sample with normal saline to obtain a sample homogenate, wherein the content of the to-be-tested sample in the sample homogenate is 5% to 20% by weight; uniformly mixing the sample homogenate with the sterilized skim milk in a volume ratio of 1:1 to 2 to obtain a standard sample.

19. The method for rapid determination of total bacterial count based on multi-wavelength reflectance spectrum according to claim 16, wherein the acquisition process of the standard curve is as follows:
sampling the to-be-tested sample for many times, randomly selecting any of collected samples, and preparing the collected sample into a standard sample;
carrying out heating treatment on the standard sample, and then measuring a first average reflected light intensity value of the standard sample at different wavelengths under the irradiation of the monochromatic light with different wavelengths;
after completing the first measurement, carrying out heating culture on the standard sample, and measuring a second average reflected light intensity value of the standard sample;
calculating a difference value between the first average reflected light intensity value and the second average reflected light intensity value;
continuing to select any of the collected samples, repeating the steps above until the difference value of the average reflected light intensity values of all collected samples is obtained; and
establishing a standard curve for the difference value of the reflected light intensity values and the true value of the total bacterial count by using the difference value of the average reflected light intensity values of all collected samples.

20. The method for rapid determination of total bacterial count based on multi-wavelength reflectance spectrum according to claim 19, wherein the acquisition process of the true value of the total bacterial count is as follows: the total bacterial count of the standard sample subject to heating culture is tested according to the testing of the Chinese standard GB4789.2-2016 is the true value of the total bacterial count.
